(19) United States
(12) Patent Application Publication
(10) Pub. No.: US 2026/0327733 A1
(43) Pub. Date: Oct. 22, 2026

(54) NON-ORIENTED ELECTRICAL STEEL SHEET AND METHOD FOR MANUFACTURING SAME

(71) Applicant: Hyundai Steel Company, Incheon (KR)

(72) Inventors: Kyeong Sik Shin, Incheon (KR); Yong Keun Ahn, Incheon (KR); Seong Tae Kim, Incheon (KR)

(21) Appl. No.: 19/468,832

(22) Filed: Feb. 3, 2026

Related U.S. Application Data
(63) Continuation of application No. PCT/KR2024/015369, filed on Oct. 11, 2024.

(30) Foreign Application Priority Data
Oct. 27, 2023 (KR) 10-2023-0145277

(51) Int. Cl. C21D 9/46; C21D 6/00; C21D 8/1216; C21D 8/1244; C22C 38/00; C22C 38/02; C22C 38/04; C22C 38/06; C22C 38/12; C22C 38/14; C22C 38/16; H01F 1/147

(52) U.S. Cl. CPC C21D 9/46; C21D 6/005; C21D 6/008; C21D 8/1222; C21D 8/1233; C21D 8/1261; C22C 38/001; C22C 38/002; C22C 38/004; C22C 38/02; C22C 38/04; C22C 38/06; C22C 38/12; C22C 38/14; C22C 38/16; H01F 1/14791; C22C 2202/02

(57) ABSTRACT

Provided is a non-oriented electrical steel sheet including silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities.

### CROSS-REFERENCE TO RELATED APPLICATION

This application is a continuation of International Application No. PCT/KR2024/015369 filed Oct. 11, 2024 which claims priority under 35 U.S.C. § 119 to Korean Patent Application No. 10-2023-0145277, filed on Oct. 27, 2023, in the Korean Intellectual Property Office, the disclosure of which applications are incorporated by reference herein in their entirety.

### 1. FIELD

The present disclosure relates to a non-oriented electrical steel sheet and a method of manufacturing the same.

### 2. BACKGROUND

Recently, with the worldwide strengthening of environmental regulations, the automotive industry has shifted from conventional internal combustion engines to eco-friendly cars (e.g., hybrid cars and electric cars). Unlike conventional internal combustion engines powered by fossil fuel, eco-friendly cars generate power from motors powered by batteries.

For improvement of motor efficiency, electric car driving motors have required improved magnetic properties of non-oriented electrical steel sheets used as motor core materials, and the development of electric car driving motors has been accelerated with increasing demand for electric cars.

In general, electrical steel sheets are classified into grain-oriented electrical steel sheets and non-oriented electrical steel sheets, and the grain-oriented electrical steels are mainly used in fixed components such as transformers. On the other hand, the non-oriented electrical steel sheets are mainly used in rotating car driving motors because they have a uniform magnetic property in all directions regardless of rolling directions.

A non-oriented electrical steel sheet has to uniformly generate a <100> orientation texture, which facilitates magnetization, throughout the sheet and has to reduce a core loss and increase a magnetic flux density for energy efficiency. In this case, the core loss refers to an energy loss generated in a magnetization process, and the magnetic flux density refers to a force for generating power.

Various factors affecting the magnetic property of a non-oriented electrical steel sheet include chemical composition, steel sheet thickness, microstructure, insulating coating layer, texture, and material shape. These various factors are affected by the process of manufacturing a non-oriented electrical steel sheet. A non-oriented electrical steel sheet is manufactured through processes such as steelmaking/continuous casting, hot rolling, hot pre-annealing, cold rolling, and heat treatment/coating, and an electrical steel sheet with an excellent magnetic property may be manufactured by optimizing such process conditions.

Also, a driving motor may be manufactured by punching and then laminating thin electrical steel sheets of 0.5 mm or less. The punchability of electrical steel sheets is a factor affecting the final performance of a driving motor, and when a burr occurs after punching, a shape defect, stress, a reduced insulating property, or the like may occur during the lamination of steel sheets.

### SUMMARY

Embodiments of the present disclosure may provide a non-oriented electrical steel sheet with excellent punchability and a method of manufacturing the same by controlling the alloy component of a non-oriented electrical steel sheet.

According to an embodiment of the present disclosure, a method of manufacturing a non-oriented electrical steel sheet includes producing a hot-rolled plate by hot-rolling a slab including silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities, producing a hot-annealed plate by hot-annealing the produced hot-rolled plate, producing a cold-rolled plate by cold-rolling the hot-annealed plate, and producing a cold-annealed plate by cold-annealing the cold-rolled plate, wherein contents of sulfur(S), nitrogen (N), titanium (Ti), zirconium (Zr), niobium (Nb), phosphorus (P), and copper (Cu) included in the slab satisfy Relationship 1 below.

2.75≤log(5*[S]+21*[N]+11*[Ti]+12*[Zr]+18*[Nb]+6*[P]+11*[Cu])≤3.70 <Relationship 1>

In Relationship 1, [S], [N], [Ti], [Zr], [Nb], [P], and [Cu] respectively denote the contents (in ppm) of sulfur(S), nitrogen (N), titanium (Ti), zirconium (Zr), niobium (Nb), phosphorus (P), and copper (Cu) included in the slab.

In another aspect, a method of manufacturing a non-oriented electrical steel sheet is provided, the method comprising:
a) hot-rolling a slab to produce a hot-rolled plate, wherein the slab comprises silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities;
b) hot-annealing the hot-rolled plate to thereby produce a hot-annealed plate;
c) cold-rolling the hot-annealed plate o thereby produce a cold rolled plate; and
d) cold-annealing the cold-rolled plate to produce a cold-annealed plate,
wherein contents of sulfur(S), nitrogen (N), titanium (Ti), zirconium (Zr), niobium (Nb), phosphorus (P), and copper (Cu) included in the slab satisfy Relationship 1 below

2.75≤log(5*[S]+21*[N]+11*[Ti]+12*[Zr]+18*[Nb]+6*[P]+11*[Cu])≤3.70 <Relationship 1>
where [S], [N], [Ti], [Zr], [Nb], [P], and [Cu] respectively denote the contents (in ppm) of sulfur(S), nitrogen (N), titanium (Ti), zirconium (Zr), niobium (Nb), phosphorus (P), and copper (Cu) included in the slab.

In another aspect, a method of manufacturing a non-oriented electrical steel sheet, the method comprising:
a) hot-rolling a slab to produce a hot-rolled plate, wherein the slab comprises silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities;
b) hot-annealing the hot-rolled plate to thereby produce a hot-annealed plate;
c) cold-rolling the hot-annealed plate o thereby produce a cold rolled plate; and
d) cold-annealing the cold-rolled plate to produce a cold-annealed plate.

In aspects of such method, the contents of silicon (Si), manganese (Mn), and aluminum (Al) included in the slab satisfy Relationship 2 below:

1.55≤log(10.1169+(11.75*[Si]+6.2*[Mn]+8.76*[Al]))≤1.80 <Relationship 2>
where [Si], [Mn], and [Al] respectively denote the contents (in wt %) of silicon (Si), manganese (Mn), and aluminum (Al) included in the slab. In the present embodiment, when the non-oriented electrical steel sheet is punched, a shear surface, a fracture surface, and a burr may be formed in the non-oriented electrical steel sheet.

In the present embodiment, a ratio of the shear surface suitably may be 45% to 100%, and a ratio of the fracture surface may be 0% to 55%.

In the present embodiment, a ratio of a length of the burr to a thickness of the non-oriented electrical steel sheet suitably may be 3.5% or less.

In the present embodiment, contents of silicon (Si), manganese (Mn), and aluminum (Al) included in the slab may satisfy Relationship 2 below.

1.55≤log(10.1169+(11.75*[Si]+6.2*[Mn]+8.76*[Al]))≤1.80 <Relationship 2>

In Relationship 2, [Si], [Mn], and [Al] may respectively denote the contents (in wt %) of silicon (Si), manganese (Mn), and aluminum (Al) included in the slab.

In the present embodiment, an average grain size of the non-oriented electrical steel sheet may be 50 μm to 150 μm.

In the present embodiment, the non-oriented electrical steel sheet suitably may have a core loss (based on W_{15/50}) of 3.0 W/kg or less. As referred to herein, The core loss W_{15/50} is core loss at a magnetic flux density of 1.5 T and a frequency of 50 Hz.

According to another embodiment of the present disclosure, a non-oriented electrical steel sheet includes silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities, wherein contents of sulfur(S), nitrogen (N), titanium (Ti), zirconium (Zr), niobium (Nb), phosphorus (P), and copper (Cu) included in the non-oriented electrical steel sheet satisfy Relationship 3 below.

2.75≤log(5*[S]+21*[N]+11*[Ti]+12*[Zr]+18*[Nb]+6*[P]+11*[Cu])≤3.70 <Relationship 3>

In Relationship 3, [S], [N], [Ti], [Zr], [Nb], [P], and [Cu] respectively denote the contents (in ppm) of sulfur(S), nitrogen (N), titanium (Ti), zirconium (Zr), niobium (Nb), phosphorus (P), and copper (Cu) included in the non-oriented electrical steel sheet.

In the present embodiment, when the non-oriented electrical steel sheet is punched, a shear surface, a fracture surface, and a burr may be formed in the non-oriented electrical steel sheet.

In the present embodiment, a ratio of the shear surface may be 45% to 100%, and a ratio of the fracture surface may be 0% to 55%.

In the present embodiment, a ratio of a length of the burr to a thickness of the non-oriented electrical steel sheet may be 3.5% or less.

In the present embodiment, contents of silicon (Si), manganese (Mn), and aluminum (Al) included in the non-oriented electrical steel sheet may satisfy Relationship 4 below.

1.55≤log(10.1169+(11.75*[Si]+6.2*[Mn]+8.76*[Al]))≤1.80 <Relationship 4>

In Relationship 4, [Si], [Mn], and [Al] may respectively denote the contents (in wt %) of silicon (Si), manganese (Mn), and aluminum (Al) included in the non-oriented electrical steel sheet.

In the present embodiment, an average grain size of the non-oriented electrical steel sheet may be 50 μm to 150 μm.

In the present embodiment, the non-oriented electrical steel sheet may have a core loss (based on W_{15/50}) of 3.0 W/kg or less.

As described above, according to an embodiment of the present disclosure, the punchability may be improved by controlling the alloy components of the non-oriented electrical steel sheet. However, the scope of the present disclosure is not limited to these effects.

### BRIEF DESCRIPTION OF DRAWINGS

FIG. 1 is a flowchart schematically illustrating a method of manufacturing a non-oriented electrical steel sheet according to an embodiment of the present disclosure.

FIG. 2 schematically illustrates a cross-section of a non-oriented electrical steel sheet after a punching process according to an embodiment of the present disclosure.

### DETAILED DESCRIPTION

The present disclosure may include various embodiments and modifications, and certain embodiments thereof are illustrated in the drawings and will be described herein in detail. The advantages and features of the present disclosure and the accomplishing methods thereof will become apparent from the embodiments described below in detail with reference to the accompanying drawings. However, the present disclosure is not limited to the embodiments described below, and may be embodied in various modes.

It will be understood that although terms such as “first” and “second” may be used herein to describe various elements, these elements should not be limited by these terms and these terms are only used to distinguish one element from another element.

As used herein, the singular forms “a”, “an”, and “the” are intended to include the plural forms as well, unless the context clearly indicates otherwise.

It will be understood that terms such as “comprise,” “include,” and “have” used herein specify the presence of stated features or components, but do not preclude the presence or addition of one or more other features or components.

Sizes of elements in the drawings may be exaggerated for convenience of description. In other words, because the sizes and shapes of components in the drawings are arbitrarily illustrated for convenience of description, the present disclosure is not limited thereto.

When a certain embodiment may be implemented differently, a particular process order may be performed differently from the described order. For example, two processes described in succession may be performed substantially at the same time or may be performed in an order opposite to the described order.

As used herein, “A and/or B” represents the case of A, B, or A and B. Also, “at least one of A and B” represents the case of A, B, or A and B.

Hereinafter, embodiments will be described in detail with reference to the accompanying drawings, and in the following description, like reference numerals will denote like elements and redundant descriptions thereof will be omitted.

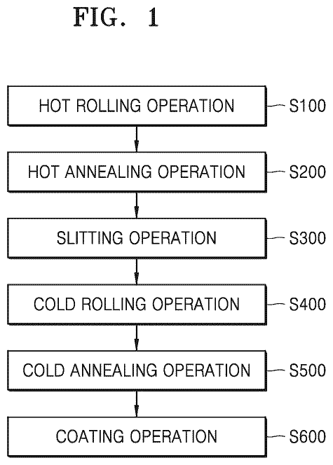

FIG. 1 is a flowchart schematically illustrating a method of manufacturing a non-oriented electrical steel sheet according to an embodiment of the present disclosure.

Referring to FIG. 1, the method of manufacturing a non-oriented electrical steel sheet may include a hot rolling operation S100, a hot annealing operation S200, a slitting operation S300, a cold rolling operation S400, a cold annealing operation S500, and a coating operation S600.

In the method of manufacturing a non-oriented electrical steel sheet according to an embodiment of the present disclosure, a semi-finished product subjected to hot rolling may be a slab. The slab in a semi-finished state may be obtained through a continuous casting process after obtaining molten steel of a certain composition through a steelmaking process.

First, the slab may be produced through a continuous casting process. The slab may include silicon (Si), aluminum (Al), manganese (Mn), carbon (C), sulfur(S), nitrogen (N), titanium (Ti), zirconium (Zr), niobium (Nb), phosphorus (P), copper (Cu), remainder iron (Fe), and unavoidable impurities.

Particularly, the slab may include silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities.

Silicon (Si) may be a main additive element as a component that reduces an eddy current loss by increasing the resistivity of a manufactured non-oriented electrical steel sheet. The content of silicon (Si) may be 2.0 wt % to 3.8 wt %. When the content of silicon (Si) is less than 2.0 wt %, it may be difficult to achieve a target core loss value of the manufactured non-oriented electrical steel sheet. Particularly, when the content of silicon (Si) is less than 2.0 wt %, it may be difficult to achieve a low core loss. On the other hand, a magnetic permeability and a magnetic flux density may decrease as the content of silicon (Si) increases. When the content of silicon (Si) is more than 3.8 wt %, the magnetic flux density may decrease, the difficulty of the manufacturing process may increase, and the manufacturing cost may increase. Also, when the content of silicon (Si) is more than 3.8 wt %, the brittleness may increase and thus a crack and/or a plate fracture may occur during cold rolling.

Manganese (Mn) may increase the resistivity of the manufactured non-oriented electrical steel sheet in cooperation with silicon (Si) and improve the texture thereof. The content of manganese (Mn) may be 0.1 wt % to 0.5 wt %. When the content of manganese (Mn) is less than 0.1 wt %, a fine MnS precipitate may be formed to suppress the grain growth. On the other hand, when the content of manganese (Mn) is more than 0.5 wt %, a coarse MnS precipitate may be formed to cause a degraded magnetic property such as a reduced magnetic flux density. Also, when the content of manganese (Mn) is more than 0.5 wt %, the core loss reduction may be small in comparison with the addition amount and the cold rollability may be degraded.

Aluminum (Al) may be a main additive element as a component that reduces an eddy current loss by increasing the resistivity of the manufactured non-oriented electrical steel sheet in cooperation with silicon (Si). The content of aluminum (Al) may be 0.1 wt % to 1.3 wt %. Aluminum (Al) may react with nitrogen to induce an AlN precipitation, and when the content of aluminum (Al) is more than 1.3 wt %, AlN may be formed to increase the core loss of the manufactured non-oriented electrical steel sheet and suppress the grain growth. Also, when the content of aluminum (Al) is more than 1.3 wt %, the cold rollability may degrade and the magnetic flux density may decrease to degrade the magnetic property.

Carbon (C) may be a component that increases the core loss by forming carbide such as TiC and NbC, and the content of carbon (C) in the slab may be lower. The content of carbon (C) may be 0 wt % exclusive to 0.003 wt %. When the content of carbon (C) is more than 0.003 wt %, magnetic aging may occur to degrade the magnetic property of the manufactured non-oriented electrical steel sheet. When the content of carbon (C) is less than 0.003 wt %, the magnetic aging may be suppressed. When the content of carbon (C) is converted into parts per million (ppm) units, the content of carbon (C) may be 0 ppm exclusive to 30 ppm.

Phosphorus (P) may be a grain boundary segregation element and may be a component that develops the texture. The content of phosphorus (P) may be 0.001 wt % to 0.015 wt %. When the content of phosphorus (P) is more than 0.015 wt %, the grain growth may be suppressed due to the segregation effect, the magnetic property may be degraded, and the cold rollability may be degraded. When the content of phosphorus (P) is converted into ppm units, the content of phosphorus (P) may be 10 ppm to 150 ppm.

Sulfur(S) may a component that forms a precipitate such as MnS or CuS to increase the core loss and suppress the grain growth. Thus, the content of sulfur(S) in the slab may be low. The content of sulfur(S) may be 0 wt % exclusive to 0.003 wt %. When the content of sulfur(S) is more than 0.003 wt %, a precipitate such as MnS or CuS may be formed to increase the core loss and suppress the grain growth. When the content of sulfur(S) is converted into ppm units, the content of sulfur(S) may be 0 ppm exclusive to 30 ppm.

Nitrogen (N) may form a precipitate such as AlN, TiN, or NbN to increase the core loss and suppress the grain growth. Thus, the content of nitrogen (N) in the slab may be low. The content of nitrogen (N) may be 0 wt % exclusive to 0.003 wt %. When the content of nitrogen (N) is more than 0.003 wt %, a precipitate such as AlN, TiN, or NbN may be formed to increase the core loss and suppress the grain growth. When the content of nitrogen (N) is converted into ppm units, the content of nitrogen (N) may be 0 ppm exclusive to 30 ppm.

Titanium (Ti) may form a fine precipitate such as TiC or TiN to suppress the grain growth. Because the magnetic property is degraded as more titanium (Ti) is added, as little titanium (Ti) as possible may be added. The content of titanium (Ti) may be 0 wt % exclusive to 0.003 wt %. When the content of titanium (Ti) is more than 0.003 wt %, it may form a fine precipitate such as TiC or TiN to suppress the grain growth and degrade the magnetic property. When the content of titanium (Ti) is converted into ppm units, the content of titanium (Ti) may be 0 ppm exclusive to 30 ppm.

Zirconium (Zr) may react with carbon and nitrogen to form a fine precipitate and suppress the grain growth. Because the texture is poorly formed as the amount of zirconium (Zr) added increases, the content of zirconium (Zr) may be 0 wt % exclusive to 0.003 wt %. When the content of zirconium (Zr) is converted into ppm units, the content of zirconium (Zr) may be 0 ppm exclusive to 30 ppm.

Niobium (Nb) may form a fine precipitate such as NbC to suppress the grain growth and develop a structure unfavorable to magnetism. The content of niobium (Nb) may be 0 wt % exclusive to 0.003 wt %. When the content of niobium (Nb) is more than 0.003 wt %, a fine precipitate such as NbC may be formed to suppress the grain growth and degrade the magnetic property. When the content of niobium (Nb) is converted into ppm units, the content of niobium (Nb) may be 0 ppm exclusive to 30 ppm.

Copper (Cu) may form a sulfide with manganese. Also, the formed precipitate may suppress the grain growth. The content of copper (Cu) may be 0 wt % exclusive to 0.02 wt %. When the content of copper (Cu) is more than 0.02 wt %, a high-temperature brittleness may occur to cause a crack during continuous casting or hot rolling. When the content of copper (Cu) is converted into ppm units, the content of copper (Cu) may be 0 ppm exclusive to 200 ppm.

In an embodiment, the contents of sulfur(S), nitrogen (N), titanium (Ti), zirconium (Zr), niobium (Nb), phosphorus (P), and copper (Cu) included in the slab may satisfy Relationship 1 below.

2.75≤log(5*[S]+21*[N]+11*[Ti]+12*[Zr]+18*[Nb]+6*[P]+11*[Cu])≤3.70 <Relationship 1>

In Relationship 1, [S], [N], [Ti], [Zr], [Nb], [P], and [Cu] may respectively denote the contents (in ppm) of sulfur(S), nitrogen (N), titanium (Ti), zirconium (Zr), niobium (Nb), phosphorus (P), and copper (Cu) included in the slab. For example, when the content of sulfur(S) in the slab is 5 ppm, [S] may be 5.

When the value of Relationship 1 is less than 2.75, the ratio of the length of a burr to the thickness of the non-oriented electrical steel sheet may be more than 3.5% and thus a shape defect, stress, a reduced insulating property, or the like may occur during the lamination of the manufactured non-oriented electrical steel sheet. Also, when the value of Relationship 1 is more than 3.70, a fracture surface ratio may be more than 55% and thus a crack may occur.

Thus, when the contents (in ppm) of sulfur(S), nitrogen (N), titanium (Ti), zirconium (Zr), niobium (Nb), phosphorus (P), and copper (Cu) in the slab satisfy Relationship 1, the ratio of the length of the burr to the thickness of the non-oriented electrical steel sheet formed in punching may be 3.5% or less and the occurrence of a crack may be prevented or minimized. This will be described below in more detail.

In an embodiment, the contents of silicon (Si), manganese (Mn), and aluminum (Al) included in the slab may satisfy Relationship 2 below.

1.55≤log(10.1169+(11.75*[Si]+6.2*[Mn]+8.76*[Al]))≤1.80 <Relationship 2>

In Relationship 2, [Si], [Mn], and [Al] may respectively denote the contents (in wt %) of silicon (Si), manganese (Mn), and aluminum (Al) included in the slab. For example, when the content of silicon (Si) in the slab is 2.0 wt %, [Si] may be 2.0.

When the value of Relationship 2 is less than 1.55, the core loss of the manufactured non-oriented electrical steel sheet may be more than 3.0 W/kg. On the other hand, when the value of Relationship 2 is more than 1.80, the core loss may be excellent but the cold rollability may be degraded and thus a crack or a plate fracture may occur. Thus, when the value of Relationship 2 is 1.55 to 1.80, the manufactured non-oriented electrical steel sheet may have a core loss of 3.0 W/kg or less and the occurrence of a crack and/or a plate fracture in the steel sheet during cold rolling may be prevented or minimized. This will be described below in more detail.

In the hot rolling operation S100, the slab may be reheated and then the reheated slab may be hot-rolled to produce a hot-rolled plate. For example, a steel sheet having undergone the hot rolling operation S100 may be referred to as a hot-rolled plate.

First, in the hot rolling operation S100, the slab may be reheated. The slab reheating temperature may be 1,000° C. to 1,250° C. When the slab reheating temperature is lower than 1,000° C., the rolling load during hot rolling (e.g., rough rolling and/or final rolling) may increase and thus the rollability may degrade. On the other hand, when the slab reheating temperature is higher than 1,250° C., a precipitate such as C, S, or N in the slab may be redissolved and thus a fine precipitate may be formed in the subsequent rolling and annealing operation, which may suppress the grain growth and degrade the magnetic property.

In the hot rolling operation S100, the slab may be rolled at a certain final rolling temperature. In this case, the final rolling temperature may be 850° C. to 950° C.

Also, in the hot rolling operation S100, the hot-rolled steel sheet may be cooled to a certain coiling temperature (CT) and then coiled. In this case, the coiling temperature may be 550° C. to 680° C.

The thickness of the hot-rolled plate produced through the hot rolling operation S100 may be 1.8 mm to 2.6 mm. In this case, when the thickness of the hot-rolled plate is more than 2.6 mm, the cold rolling reduction rate may increase and thus the texture may degrade.

The hot annealing operation S200 may be performed after the hot rolling operation S100. In the hot annealing operation S200, the hot-rolled plate may be annealed to produce a hot-annealed plate. For example, a steel sheet having undergone the hot annealing operation S200 may be referred to as a hot-annealed plate.

In the hot annealing operation S200, the hot-rolled plate may be heated to a hot annealing temperature at a temperature rise rate (or a heating rate) of 20° C./s or more, then annealed at a hot annealing temperature for 30 seconds to 150 seconds, and then cooled at a cooling rate of 20° C./s or more. In this case, the hot annealing temperature may be 950° C. to 1,100° C. When the hot annealing temperature is lower than 950° C., the grain growth may not be sufficient and thus fine grains may be formed, thus degrading the magnetism of the manufactured non-oriented electrical steel sheet. Also, when the hot annealing temperature is lower than 950° C., fine inclusions such as carbide and nitride may be formed from the surface layer and the inclusions may not grow sufficiently, thus degrading the magnetism of the manufactured non-oriented electrical steel sheet. On the other hand, when the hot annealing temperature is higher than 1,100° C., the grain may grow excessively to increase the grain size deviation and the oxidation may occur significantly to adversely affect the manufactured non-oriented electrical steel sheet.

The slitting operation S300 may be performed after the hot annealing operation S200. In the slitting operation S300, the coiled steel sheet (e.g., the hot-annealed plate or the hot-rolled plate) may be uncoiled and then the steel sheet (e.g., the hot-annealed plate or the hot-rolled plate) may be cut by using a knife or the like and then the cut steel sheet (e.g., the hot-annealed plate or the hot-rolled plate) may be coiled.

In an embodiment, in the slitting operation S300, the steel sheet (e.g., the hot-annealed plate or the hot-rolled plate) may be cut by using a knife or the like. For example, in the slitting operation S300, the steel sheet (e.g., the hot-annealed plate or the hot-rolled plate) may be divided into three equal parts in the width direction, or the steel sheet (e.g., the hot-annealed plate or the hot-rolled plate) may be divided into four equal parts in the width direction. Alternatively, in the slitting operation S300, both edge portions of the steel sheet (e.g., the hot-annealed plate or the hot-rolled plate) may be slit.

The cold rolling operation S400 may be performed after the slitting operation S300. In the cold rolling operation S400, the slit hot-annealed plate may be cold-rolled to produce a cold-rolled plate. For example, a steel sheet having undergone the cold rolling operation S400 may be referred to as a cold-rolled plate.

Before the cold rolling operation S400, a pickling solution may be used to remove an oxide layer formed on the surface of the hot-annealed plate.

In the cold rolling operation S400, the hot-annealed plate may be cold-rolled to a thickness of 0.5 mm or less. In this case, in order to provide rollability, the plate temperature may be increased to 150° C. to 200° C. and then warm rolling may be performed. The reduction ratio in the cold rolling operation S400 may be 50% or more. The final reduction ratio in the cold rolling operation S400 may be 70% to 95%.

The cold annealing operation S500 may be performed after the cold rolling operation S400. In the cold annealing operation S500, the cold-rolled plate may be annealed to produce a cold-annealed plate. For example, a steel sheet having undergone the cold annealing operation S500 may be referred to as a cold-annealed plate.

In the cold annealing operation S500, the cold-rolled plate may be heated to a cold annealing temperature (e.g., a target temperature) at a temperature rise rate (or a heating rate) of 5° C./s to 30° C./s, then annealed at a cold annealing temperature for 40 seconds to 300 seconds, and then cooled at a cooling rate of 20° C./s or more. In this case, the cold annealing temperature may be 800° C. to 1,100° C. When the cold annealing temperature is lower than 800° C., the grain size may be fine and thus a hysteresis loss may increase. On the other hand, when the cold annealing temperature is higher than 1,100° C., the grain size may become coarse and thus an eddy current loss may increase.

In order to prevent surface oxidation and nitration, the cold annealing operation S500 may be performed under a mixed atmosphere. For example, a mixed atmosphere of nitrogen and hydrogen may be used to further smooth the surface state.

The coating operation S600 may be performed after the cold annealing operation S500. In the coating operation S600, a coating layer may be formed on the cold-annealed plate. The formation of the coating layer through the coating operation S600 may improve the punchability and secure the insulating property.

In an embodiment, a non-oriented electrical steel sheet may be manufactured through the hot rolling operation S100 to the coating operation S600.

The non-oriented electrical steel sheet according to an embodiment of the present disclosure may include silicon (Si), aluminum (Al), manganese (Mn), carbon (C), sulfur(S), nitrogen (N), titanium (Ti), zirconium (Zr), niobium (Nb), phosphorus (P), copper (Cu), remainder iron (Fe), and unavoidable impurities.

Particularly, the non-oriented electrical steel sheet may include silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities.

The average grain size of the non-oriented electrical steel sheet manufactured by the method of manufacturing a non-oriented electrical steel sheet according to an embodiment of the present disclosure may be 50 μm to 150 μm. Also, the non-oriented electrical steel sheet manufactured by the method of manufacturing a non-oriented electrical steel sheet according to an embodiment of the present disclosure may have a core loss of 3.0 W/kg or less (based on W_{15/50}) and a magnetic flux density of 1.60 T or more (based on B₅₀). Also, the non-oriented electrical steel sheet manufactured by the method of manufacturing a non-oriented electrical steel sheet according to an embodiment of the present disclosure may have a yield strength (YP) of 200 MPa or more and a tensile strength (TS) of 350 MPa or more.

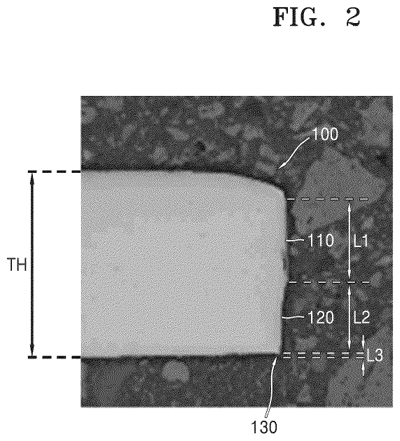

FIG. 2 schematically illustrates a cross-section of a non-oriented electrical steel sheet after a punching process according to an embodiment of the present disclosure.

Referring to FIG. 2, when a punching process is performed on a non-oriented electrical steel sheet 100 according to an embodiment of the present disclosure, a shear surface 110, a fracture surface 120, and a burr 130 may be formed on the non-oriented electrical steel sheet 100.

In an embodiment, the shear surface 110 may be a surface that extends in a thickness direction of the non-oriented electrical steel sheet 100 or at a certain angle with respect to the thickness direction. The shear surface 110 may have a smooth surface. Alternatively, the shear surface 110 may be formed in a straight line within the thickness range of the material when analyzed from the side after the punching and may have a low roughness when observed from the front.

In an embodiment, the fracture surface 120 may be a surface that is formed when the non-oriented electrical steel sheet 100 is fractured. The fracture surface 120 may be irregular compared to the shear surface 110. The fracture surface 120 may have an irregular surface. Alternatively, the fracture surface 120 may be formed in a diagonal line within the thickness range of the material when analyzed from the side after the punching and may have a rough surface when observed from the front.

In an embodiment, the burr 130 may be formed on the non-oriented electrical steel sheet 100 in the punching process. Alternatively, the burr 130 may refer to a portion that is formed outside the thickness range of the material when analyzed from the side after the punching.

Also, in an embodiment, a rollover may be formed on the non-oriented electrical steel sheet 100. Compressive stress generated in the punching may cause plastic deformation of the material as the punching process progresses, and a rollover may be formed because pressure occurs as the material is bent due to the plastic deformation of the material. The rollover may be affected by the material quality or the clearance condition.

In an embodiment, the shear surface ratio (%) may be 45% to 100% (or 45% to 100% exclusive). In this case, the shear surface ratio (%) may be calculated as L1/TH*100. In this case, TH may be the thickness of the non-oriented electrical steel sheet 100, and L1 may be the length of the shear surface 110 in the thickness direction of the non-oriented electrical steel sheet 100. That is, the shear surface ratio (%) may refer to the ratio of the shear surface 110 to the thickness of the non-oriented electrical steel sheet 100. Also, the thickness TH of the non-oriented electrical steel sheet 100 and the length L1 of the shear surface 110 in the thickness direction of the non-oriented electrical steel sheet 100 may be measured by using an optical microscope (OM).

In an embodiment, the fracture surface ratio (%) may be 0% to 55% (or 0% exclusive to 55%). In this case, the fracture surface ratio (%) may be calculated as L2/TH*100. In this case, TH may be the thickness of the non-oriented electrical steel sheet 100, and L2 may be the length of the fracture surface 120 in the thickness direction of the non-oriented electrical steel sheet 100. That is, the fracture surface ratio (%) may refer to the ratio of the fracture surface 120 to the thickness of the non-oriented electrical steel sheet 100. Also, the thickness TH of the non-oriented electrical steel sheet 100 and the length L2 of the fracture surface 120 in the thickness direction of the non-oriented electrical steel sheet 100 may be measured by using an optical microscope (OM). When the fracture surface ratio (%) is more than 55%, the magnetic property may be degraded. Also, when the fracture surface ratio (%) is more than 55%, the residual stress may increase and it may be difficult to form a sound lamination surface during lamination.

In an embodiment, the ratio of the length of the burr 130 to the thickness of the non-oriented electrical steel sheet 100 may be 3.5% or less. In this case, the ratio of the length of the burr 130 to the thickness TH of the non-oriented electrical steel sheet 100 may be calculated as L3/TH*100. In this case, L3 may be the length of the burr 130 in the thickness direction of the non-oriented electrical steel sheet 100, and TH may be the thickness of the non-oriented electrical steel sheet 100 in the thickness direction of the non-oriented electrical steel sheet 100. When the ratio of the length L3 of the burr 130 to the thickness TH of the non-oriented electrical steel sheet 100 is more than 3.5%, a shape defect, stress, a reduced insulating property, or the like may occur during the lamination of the non-oriented electrical steel sheet 100.

In an embodiment, the contents of sulfur(S), nitrogen (N), titanium (Ti), zirconium (Zr), niobium (Nb), phosphorus (P), and copper (Cu) included in the non-oriented electrical steel sheet may satisfy Relationship 3 below.

2.75≤log(5*[S]+21*[N]+11*[Ti]+12*[Zr]+18*[Nb]+6*[P]+11*[Cu])≤3.70 <Relationship 3>

In Relationship 3, [S], [N], [Ti], [Zr], [Nb], [P], and [Cu] may respectively denote the contents (in ppm) of sulfur(S), nitrogen (N), titanium (Ti), zirconium (Zr), niobium (Nb), phosphorus (P), and copper (Cu) included in the non-oriented electrical steel sheet. For example, when the content of sulfur(S) in the non-oriented electrical steel sheet is 5 ppm, [S] may be 5.

When the value of Relationship 3 is less than 2.75, the length of the burr formed in the punching process may increase and thus a shape defect, stress, a reduced insulating property, or the like may occur during the lamination of the non-oriented electrical steel sheet. Particularly, when the value of Relationship 3 is less than 2.75, the ratio of the length L3 of the burr 130 to the thickness TH of the non-oriented electrical steel sheet 100 may be more than 3.5% and thus a shape defect, stress, a reduced insulating property, or the like may occur during the lamination of the non-oriented electrical steel sheet. Also, when the value of Relationship 3 is more than 3.70, the fracture surface ratio may be more than 55% and thus a crack may occur.

Thus, when the content (in ppm) of sulfur(S), nitrogen (N), titanium (Ti), zirconium (Zr), niobium (Nb), phosphorus (P), and copper (Cu) included in the slab satisfies Relationship 3, the ratio of the length L3 of the burr 130 to the thickness TH of the non-oriented electrical steel sheet 100 may be 3.5% or less and thus the occurrence of a shape defect, stress, a reduced insulating property, or the like during the lamination of the non-oriented electrical steel sheet 100 may be prevented or minimized and the occurrence of a crack may be prevented or minimized. This will be described below in more detail.

In an embodiment, the contents of silicon (Si), manganese (Mn), and aluminum (Al) included in the non-oriented electrical steel sheet may satisfy Relationship 4 below.

1.55≤log(10.1169+(11.75*[Si]+6.2*[Mn]+8.76*[Al]))≤1.80 <Relationship 4>

In Relationship 4, [Si], [Mn], and [Al] may respectively denote the contents (in wt %) of silicon (Si), manganese (Mn), and aluminum (Al) included in the non-oriented electrical steel sheet. For example, when the content of silicon (Si) in the non-oriented electrical steel sheet is 2.0 wt %, [Si] may be 2.0.

When the value of Relationship 4 is less than 1.55, the core loss of the non-oriented electrical steel sheet 100 may be more than 3.0 W/kg. On the other hand, when the value of Relationship 4 is more than 1.80, the core loss may be excellent but the cold rollability may be degraded and thus a crack or a plate fracture may occur. Thus, when the value of Relationship 4 is 1.55 to 1.80, the non-oriented electrical steel sheet 100 may have a core loss of 3.0 W/kg or less and the occurrence of a crack and/or a plate fracture in the steel sheet during cold rolling may be prevented or minimized. This will be described below in more detail.

### Experimental Example

Hereinafter, the present disclosure will be described in more detail through the Experimental Example. However, the following Experimental Example is intended to further describe the present disclosure, and the scope of the present disclosure is not limited to the following Experimental Example. Those of ordinary skill in the art may suitably modify or change the following Experimental Example within the scope of the present disclosure.

TABLE 1

| | Component | | | | | | | | | | |
|---|---|---|---|---|---|---|---|---|---|---|---|
| | (wt %) | | | (ppm) | | | | | | | |
| Category | Si | Al | Mn | C | S | N | Ti | Zr | Nb | P | Cu |
| Embodi- | 2.0 | 0.24 | 0.14 | 19 | 21 | 12 | 8 | 8 | 16 | | |
| ment 1 | | | | | | | | | | | |
| Embodi- | 2.35 | 0.52 | 0.23 | 12 | 20 | 18 | 8 | 7 | 8 | 65 | 45 |
| ment 2 | | | | | | | | | | | |
| Embodi- | 2.62 | 0.62 | 0.41 | 20 | 24 | 12 | 10 | 12 | 14 | 46 | 30 |
| ment 3 | | | | | | | | | | | |
| Embodi- | 2.80 | 0.56 | 0.21 | 14 | 11 | 19 | 16 | 13 | 11 | 120 | 40 |
| ment 4 | | | | | | | | | | | |
| Embodi- | 3.17 | 0.80 | 0.45 | 25 | 10 | 4 | 20 | 15 | 18 | 70 | 41 |
| ment 5 | | | | | | | | | | | |
| Embodi- | 3.44 | 0.58 | 0.29 | 24 | 18 | 11 | 10 | 20 | 15 | 50 | 70 |
| ment 6 | | | | | | | | | | | |
| Compar- | 1.82 | 0.22 | 0.25 | 10 | 12 | 15 | 5 | 5 | 10 | 50 | 60 |
| ative | | | | | | | | | | | |
| Example | | | | | | | | | | | |
| 1 | | | | | | | | | | | |
| Compar- | 2.0 | 0.26 | 0.18 | 5 | 5 | 5 | 5 | 5 | 5 | 10 | 10 |
| ative | | | | | | | | | | | |
| Example | | | | | | | | | | | |
| 2 | | | | | | | | | | | |
| Compar- | 2.81 | 0.52 | 0.20 | 4 | 3 | 5 | 3 | 4 | 4 | 15 | 16 |
| ative | | | | | | | | | | | |
| Example | | | | | | | | | | | |
| 3 | | | | | | | | | | | |
| Compar- | 2.65 | 0.58 | 0.43 | 35 | 36 | 38 | 36 | 28 | 35 | 160 | 170 |
| ative | | | | | | | | | | | |
| Example | | | | | | | | | | | |
| 4 | | | | | | | | | | | |
| Compar- | 2.82 | 0.57 | 0.21 | 32 | 37 | 33 | 31 | 36 | 31 | 160 | 190 |
| ative | | | | | | | | | | | |
| Example | | | | | | | | | | | |
| 5 | | | | | | | | | | | |
| Compar- | 3.92 | 0.72 | 0.42 | 12 | 18 | 19 | 9 | 25 | 16 | 68 | 72 |
| ative | | | | | | | | | | | |
| Example | | | | | | | | | | | |
| 6 | | | | | | | | | | | |

TABLE 2

| | | | |
|---|---|---|---|
| Hot rolling operation | Slab reheating temperature | 1,200 | °C |
| | (°C) | | |
| | Final rolling temperature | 900 | °C |
| | (°C) | | |
| | Coiling temperature (°C) | 600 | °C |
| | Hot rolling thickness (mm) | 2.3 | mm |
| Hot annealing | Temperature rise rate (C/s) | 20 | °C/s |
| operation | Annealing temperature (°C) | 1,000 | °C |
| | Duration time (s) | 60 | s |
| | Cooling rate (°C/s) | 20 | °C/s |
| Cold rolling | Reduction ratio (%) | 0.27 mm | 88.3% |
| operation | | 0.30 mm | 87% |
| | | 0.35 mm | 84.8% |
| | | 0.50 mm | 78.3% |
| Cold annealing | Temperature rise rate (°C/s) | 20 | °C/s |
| operation | Annealing temperature (°C) | 950 | °C |
| | Duration time (s) | 60 | s |
| | Cooling rate (°C/s) | 20 | °C/s |

TABLE 3

| | | | Ratio of | | | |
|---|---|---|---|---|---|---|
| | | Value | length | Frac- | Value | |
| | | of | of burr | ture | of | Core |
| | Thick- | Rela- | to | surface | Rela- | loss |
| | ness | tion- | thickness | Ratio | tion- | (W_{15/50}, |
| Category | (mm) | ship 1 | (%) | (%) | ship 2 | W/kg) |
| Embodi- | 0.50 | 3.37 | 1.22 | 54.7 | 1.56 | 2.93 |
| ment 1 | | | | | | |
| Embodi- | 0.50 | 3.23 | 1.81 | 50.8 | 1.63 | 2.82 |
| ment 2 | | | | | | |
| Embodi- | 0.50 | 3.17 | 2.06 | 47.9 | 1.68 | 2.75 |
| ment 3 | | | | | | |
| Embodi- | 0.35 | 3.33 | 1.39 | 53.7 | 1.68 | 2.31 |
| ment 4 | | | | | | |
| Embodi- | 0.30 | 3.24 | 1.77 | 51.3 | 1.75 | 2.08 |
| ment 5 | | | | | | |
| Embodi- | 0.27 | 3.30 | 1.51 | 54.2 | 1.75 | 1.88 |
| ment 6 | | | | | | |
| Compar- | 0.50 | 3.21 | 1.89 | 49.8 | 1.54 | 3.12 |
| ative | | | | | | |
| Example | | | | | | |
| 1 | | | | | | |
| Compar- | 0.50 | 2.70 | 4.2 | 24.8 | 1.57 | 2.87 |
| ative | | | | | | |
| Example | | | | | | |
| 2 | | | | | | |
| Compar- | 0.35 | 2.73 | 4.0 | 26.3 | 1.68 | 2.24 |
| ative | | | | | | |
| Example | | | | | | |
| 3 | | | | | | |
| Compar- | 0.50 | 3.71 | 0.12 | 73.9 | 1.69 | 2.81 |
| ative | | | | | | |
| Example | | | | | | |
| 4 | | | | | | |
| Compar- | 0.35 | 3.72 | 0.11 | 74.8 | 1.69 | 2.36 |
| ative | | | | | | |
| Example | | | | | | |
| 5 | | | | | | |
| Compar- | 0.35 | 3.38 | 1.78 | 58.2 | 1.81 | 1.62 |
| ative | | | | | | |
| Example | | | | | | |
| 6 | | | | | | |

Embodiments 1 to 6 and Comparative Examples 1 to 6 may be samples of the slab including the components illustrated in Table 1, remainder iron (Fe), and unavoidable impurities manufactured under the process conditions illustrated in Table 2. In this case, all the samples are manufactured to the same size of a width of 80 mm and a length of 150 mm.

Embodiments 1 to 6 and Comparative Examples 1 to 6 were manufactured under the same process condition, but under the condition of different component contents.

The thickness of the samples (e.g., non-oriented electrical steel sheets), the length of the shear surface, the length of the fracture surface, and the length of the burr are measured by observing the side surface and front surface of the samples (e.g., non-oriented electrical steel sheets) at a magnification of 100 to 300 by using an optical microscope (OM).

In Table 3, the value of Relationship 1 corresponds to the value of log (5*[S]+21*[N]+11*[Ti]+12*[Zr]+18*[Nb]+6*[P]+11*[Cu]), and the value of Relationship 2 corresponds to the value of log (10.1169+ (11.75*[Si]+6.2*[Mn]+8.76*[Al])).

Referring to Embodiments 1 to 6, it may be seen that the value of Relationship 1 is 2.75 to 3.70 and the value of Relationship 2 is 1.55 to 1.80. Also, it may be seen that the ratio of the length of the burr to the thickness of the non-oriented electrical steel sheet (or sample) is 3.5% or less and the fracture surface ratio (%) is 0% to 55% (or 0% exclusive to 55%) when the value of Relationship 1 is 2.75 to 3.70. Also, it may be seen that the core loss is 3.0 W/kg or less when the value of Relationship 2 is 1.55 to 1.80.

Comparative Example 1 may correspond to a case where the value of Relationship 2 is less than 1.55, and it may be seen that the core loss of Comparative Example 1 is more than 3.0 W/kg. Thus, when the value of Relationship 2 is less than 1.55, the core loss of the manufactured non-oriented electrical steel sheet may be more than 3.0 W/kg.

Comparative Example 2 may correspond to a case where the value of Relationship 1 is less than 2.75, and it may be seen that the ratio of the length of the burr to the thickness of the non-oriented electrical steel sheet in Comparative Example 2 is more than 3.5%. In this case, when the ratio of the length of the burr to the thickness of the non-oriented electrical steel sheet is more than 3.5%, a shape defect, stress, a reduced insulating property, or the like may occur during the lamination of the non-oriented electrical steel sheet.

Comparative Example 3 may correspond to a case where the value of Relationship 1 is less than 2.75, and it may be seen that the ratio of the length of the burr to the thickness of the non-oriented electrical steel sheet in Comparative Example 3 is more than 3.5%. In this case, when the ratio of the length of the burr to the thickness of the non-oriented electrical steel sheet is more than 3.5%, a shape defect, stress, a reduced insulating property, or the like may occur during the lamination of the non-oriented electrical steel sheet.

Comparative Examples 4 and 5 may correspond to a case where the value of Relationship 1 is more than 3.70, and it may be seen that the fracture surface ratios (%) in Comparative Examples 4 and 5 are respectively 73.9% and 74.8%. A crack may occur when the fracture surface ratio (%) is more than 55%.

Comparative Example 6 may correspond to a case where the value of Relationship 2 is more than 1.80, and when the value of Relationship 2 is more than 1.80, the core loss may be 3.0 W/kg but the cold rollability may decrease and thus a plate fracture and/or a crack may occur.

Although the present disclosure has been described with reference to the embodiments illustrated in the drawings, this is merely an example and those of ordinary skill in the art will understand that various modifications and other equivalent embodiments may be derived therefrom. Thus, the spirit and scope of the present disclosure should be defined by the appended claims.

1. A method of manufacturing a non-oriented electrical steel sheet, the method comprising:
hot-rolling a slab to produce a hot-rolled plate, wherein the slab comprises silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities;
hot-annealing the hot-rolled plate to thereby produce a hot-annealed plate;
cold-rolling the hot-annealed plate o thereby produce a cold rolled plate; and
cold-annealing the cold-rolled plate to produce a cold-annealed plate,
wherein contents of sulfur(S), nitrogen (N), titanium (Ti), zirconium (Zr), niobium (Nb), phosphorus (P), and copper (Cu) included in the slab satisfy Relationship 1 below
2.75≤log(5*[S]+21*[N]+11*[Ti]+12*[Zr]+18*[Nb]+6*[P]+11*[Cu])≤3.70 <Relationship 1>
where [S], [N], [Ti], [Zr], [Nb], [P], and [Cu] respectively denote the contents (in ppm) of sulfur(S), nitrogen (N), titanium (Ti), zirconium (Zr), niobium (Nb), phosphorus (P), and copper (Cu) included in the slab.

2. The method of claim 1, wherein, when the non-oriented electrical steel sheet is punched, a shear surface, a fracture surface, and a burr are formed in the non-oriented electrical steel sheet.

3. The method of claim 2, wherein a ratio of the shear surface is 45% to 100%, and a ratio of the fracture surface is 0% to 55%.

4. The method of claim 2, wherein a ratio of a length of the burr to a thickness of the non-oriented electrical steel sheet is 3.5% or less.

5. The method of claim 1, wherein contents of silicon (Si), manganese (Mn), and aluminum (Al) included in the slab satisfy Relationship 2 below
1.55≤log(10.1169+(11.75*[Si]+6.2*[Mn]+8.76*[Al]))≤1.80 <Relationship 2>
where [Si], [Mn], and [Al] respectively denote the contents (in wt %) of silicon (Si), manganese (Mn), and aluminum (Al) included in the slab.

6. The method of claim 1, wherein an average grain size of the non-oriented electrical steel sheet is 50 μm to 150 μm.

7. The method of claim 1, wherein the non-oriented electrical steel sheet has a core loss (based on W_{15/50}) of 3.0 W/kg or less.

8. A non-oriented electrical steel sheet comprising
silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities,
wherein contents of sulfur(S), nitrogen (N), titanium (Ti), zirconium (Zr), niobium (Nb), phosphorus (P), and copper (Cu) included in the non-oriented electrical steel sheet satisfy Relationship 3 below
2.75≤log(5*[S]+21*[N]+11*[Ti]+12*[Zr]+18*[Nb]+6*[P]+11*[Cu])≤3.70 <Relationship 3>
where [S], [N], [Ti], [Zr], [Nb], [P], and [Cu] respectively denote the contents (in ppm) of sulfur(S), nitrogen (N), titanium (Ti), zirconium (Zr), niobium (Nb), phosphorus (P), and copper (Cu) included in the non-oriented electrical steel sheet.

9. The non-oriented electrical steel sheet of claim 8, wherein, when the non-oriented electrical steel sheet is punched, a shear surface, a fracture surface, and a burr are formed in the non-oriented electrical steel sheet.

10. The non-oriented electrical steel sheet of claim 9, wherein a ratio of the shear surface is 45% to 100%, and a ratio of the fracture surface is 0% to 55%.

11. The non-oriented electrical steel sheet of claim 9, wherein a ratio of a length of the burr to a thickness of the non-oriented electrical steel sheet is 3.5% or less.

12. The non-oriented electrical steel sheet of claim 8, wherein contents of silicon (Si), manganese (Mn), and aluminum (Al) included in the non-oriented electrical steel sheet satisfy Relationship 4 below
1.55≤log(10.1169+(11.75*[Si]+6.2*[Mn]+8.76*[Al]))≤1.80 <Relationship 4>
where [Si], [Mn], and [Al] respectively denote the contents (in wt %) of silicon (Si), manganese (Mn), and aluminum (Al) included in the non-oriented electrical steel sheet.

13. The non-oriented electrical steel sheet of claim 8, wherein an average grain size of the non-oriented electrical steel sheet is 50 μm to 150 μm.

14. The non-oriented electrical steel sheet of claim 8, wherein the non-oriented electrical steel sheet has a core loss (based on W_{15/50}) of 3.0 W/kg or less.

15. A method of manufacturing a non-oriented electrical steel sheet, the method comprising:
hot-rolling a slab to produce a hot-rolled plate, wherein the slab comprises silicon (Si) of 2.0 wt % to 3.8 wt %, aluminum (Al) of 0.1 wt % to 1.3 wt %, manganese (Mn) of 0.1 wt % to 0.5 wt %, carbon (C) of 0 wt % exclusive to 0.003 wt %, sulfur(S) of 0 wt % exclusive to 0.003 wt %, nitrogen (N) of 0 wt % exclusive to 0.003 wt %, titanium (Ti) of 0 wt % exclusive to 0.003 wt %, zirconium (Zr) of 0 wt % exclusive to 0.003 wt %, niobium (Nb) of 0 wt % exclusive to 0.003 wt %, phosphorus (P) of 0.001 wt % to 0.015 wt %, copper (Cu) of 0 wt % exclusive to 0.02 wt %, remainder iron (Fe), and unavoidable impurities;
hot-annealing the hot-rolled plate to thereby produce a hot-annealed plate;
cold-rolling the hot-annealed plate o thereby produce a cold rolled plate; and
cold-annealing the cold-rolled plate to produce a cold-annealed plate.

16. The method of claim 15, wherein contents of silicon (Si), manganese (Mn), and aluminum (Al) included in the slab satisfy Relationship 2 below
1.55≤log(10.1169+(11.75*[Si]+6.2*[Mn]+8.76*[Al]))≤1.80 <Relationship 2>
where [Si], [Mn], and [Al] respectively denote the contents (in wt %) of silicon (Si), manganese (Mn), and aluminum (Al) included in the slab.
